(19) United States
(12) Patent Application Publication
(10) Pub. No.: US 2005/0256772 A1
(43) Pub. Date: Nov. 17, 2005

(54) Pricing system and method for multiple discounts

(76) Inventor: Hui-Kang Tang, Taipei City (TW)

Correspondence Address: HOFFMAN WARNICK & D'ALESSANDRO, LLC, 75 STATE STREET, 14TH FL, ALBANY, NY, 12207, US

(21) Appl. No.: 11/128,754

(22) Filed: May 13, 2005

(30) Foreign Application Priority Data
May 14, 2004 (TW) 093113773

(51) Int. Cl. G06F 17/60; G06G 7/00

(52) U.S. Cl. 705/14; 705/400

(57) ABSTRACT

The invention provides a data processing system and method for pricing a plurality of goods to be purchased by a customer, based on a plurality of predetermined discount criteria. According to the invention, an amount of discount relative to N goods is generated according to some applicable discount criteria selected from the predetermined discount criteria and an order information including data associated with the goods. The pricing regarding the goods is calculated by subtracting the sum of all prices of the goods by the total amount of discount.

### BACKGROUND OF THE INVENTION

1. Field of the Invention

This present invention relates to a data processing system and method for pricing goods, more in particular, to a data processing system and method for pricing goods based on multiple discounts.

2. Description of the Prior Art

Discounting has always been one of the important ways of marketing to attract customers to consume. Merchants sell and get rid of goods in stock by giving discount while customers purchase much cheaper goods by this way.

Many technical contents of preceding patents involves the operation of giving preferential discount for customers by utilizing informational systems, such as those disclosed in U.S. Pat. Nos. 6,615,184; 6,076,071 and 5,873,069. However, previously mentioned techniques are only used to search for the lowest prices for specific products or just to supply discount prices and related information regarding specific goods.

Among real transactions, a customer may order various kinds and a number of goods; therefore, the discounts given by merchants will become more complicated. At present, there is no related technique for multiple discounts regarding the execution of preferential discounts for customers by utilizing informational system.

Therefore, the objective of the present invention is to provide a pricing system and method for multiple discounts.

### SUMMARY OF THE INVENTION

According to the data processing system of a preferred embodiment of the present invention, the system prices N goods to be purchased by a customer based on M1 predetermined discount criteria, wherein M1 and N are natural numbers respectively. The data processing system comprises a storing module, a terminal module, a discount module, and a pricing module. The storing module is used for storing M1 predetermined discount criteria. The terminal module is used for inputting an order information associated with N goods. The discount module is used for receiving the order information from the terminal module and for accessing M2 applicable discount criteria, according to the order information, from the storing module. According to the order information, the discount module selects M3 applied discount criteria from M2 applicable discount criteria. The discount module also generates an amount of discount according to M3 applied discount criteria and the order information, wherein M2 is a positive integer less than or equal to M1, and M3 is a positive integer less than or equal to M2. The pricing module is used for receiving the order information from the terminal module and the amount of discount from the discount module. The pricing module then prices N goods by subtracting the sum of all prices of N goods by the total amount of discount.

According to the data processing method of a preferred embodiment of the present invention, the method prices N goods to be purchased by a customer based on M1 predetermined discount criteria, wherein M1 and N are natural numbers respectively. Based on the data processing method of the invention, first of all, the order information comprising the information of N goods is received. Then, based on the order information, M2 applicable discount criteria are accessed from M1 predetermined discount criteria, wherein M2 is a positive integer less than or equal to M1. Next, according to the order information, M3 applied discount criteria are selected from M2 applicable discount criteria, wherein M3 is a positive integer less than or equal to M2. An amount of discount is generated according to the M3 applied discount criteria and the order information. Finally, the pricing of N goods is done by subtracting the sum of all prices of N goods by the total amount of discount.

The advantage and spirit of the invention may be understood by the following recitations together with the appended drawings.

### BRIEF DESCRIPTION OF THE APPENDED DRAWINGS

FIG. 1 is a functional block diagram of the data processing system according to the objective of the present invention.

FIG. 2 is a flow chart of the data processing system according to the objective of the present invention.

FIG. 3 is a flow chart of an embodiment of the present invention.

### DETAILED DESCRIPTION OF THE INVENTION

An objective of the present invention is to provide a data processing system and method for pricing goods, to be purchased by a customer, with multiple discounts. The first preferred embodiment of the invention is described in detail to illustrate the features, spirit, advantages, and practical simplicity of the invention.

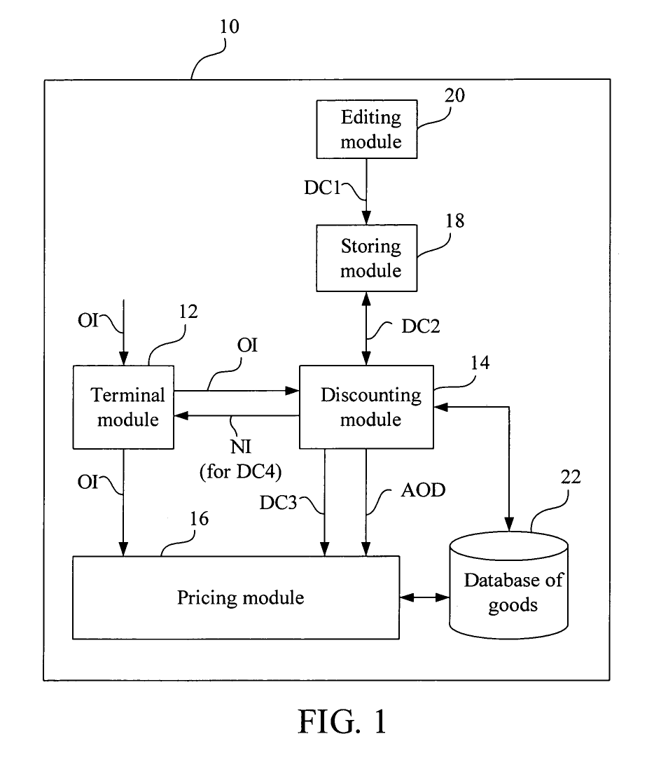

Referring to FIG. 1, FIG. 1 is a functional block diagram of the data processing system 10 according to a preferred embodiment of the present invention. The data processing system 10 prices N goods to be purchased by a customer based on M1 predetermined discount criteria (DC1), wherein M1 and N are natural numbers respectively. The data processing system 10 comprises a storing module 18, a terminal module 12, a discount module 14, and a pricing module 16.

The storing module 18 stores M1 predetermined DC1. The terminal module 12 is used to input the order information (OI 20). The OI 20 comprises the data associated with N goods such as the identification and the shopping site of the customer.

The discount module 14 receives the OI from the terminal module 12 and accesses M2 applicable discount criteria (DC2) from the storing module 18 based on the OI. The discount module 14 selects M3 applied discount criteria (DC3) from M2 applicable DC2 according to the OI. The discount module 14 then generates an amount of discount (AOD) according to the M3 applied DC3 and the OI, wherein M2 is a positive integer less than or equal to M1, and M3 is a positive integer less than or equal to M2. In a real application, the data processing system 10 should also comprise a goods database 22. When the discount module 14 calculates the AOD, it will access the prices of goods from the goods database 22 for comparison and calculation.

In addition, the discount module 14 generates (M2-M3) notice information (NI) based on (M2-M3) inapplicable discount criteria (DC4) of M2 applicable DC2 and the order information (OI). Each NI corresponds to one of the (M2-M3) inapplicable DC4. Then, the discount module 14 outputs the (M2-M3) NI into the terminal module 12; the customer can select whether to keep on purchasing based on the (M2-M3) NI, so as to achieve the (M2-M3) inapplicable DC4.

The pricing module 16 receives the OI from the terminal module 12 and the AOD from the discount module 14. The pricing module 16 is to price N goods by subtracting the sum of all prices of N goods by the AOD. In a real application, the pricing module 16 may store the information about goods prices or as illustrated in FIG. 1, so that it can calculate by accessing information of goods prices from the goods database 22.

In an embodiment, the data processing system 10 further comprises an editing module 20, as illustrated in FIG. 1. The editing module 20 selectively adds, deletes, or amends the M1 predetermined DC 1 stored in the storing module 18.

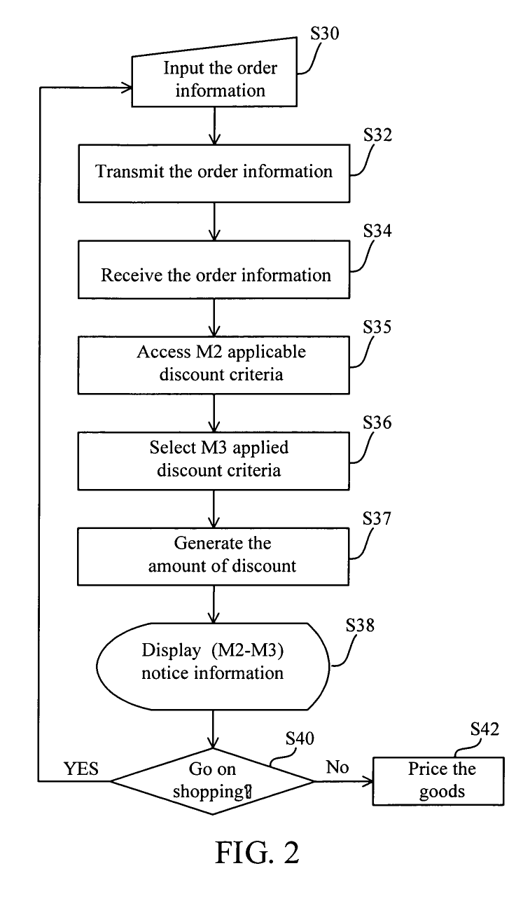

Referring to FIG. 2, FIG. 2 is a data processing flow chart of the data processing method 10 disclosed by FIG. 1. According to the data processing method of the present invention, it is used to price N goods to be purchased by a customer based on the M1 predetermined DC1, wherein M1 and N are natural numbers respectively. The following will simultaneously use the data processing system 10 of FIG. 1 to describe the method in detail according to the present invention. First, in step S30, the OI refers to the customers inputting into the terminal module 12. The OI comprises the data associated with N goods such as the identification and shopping sites of customers. Then, in the step S32, the terminal module 12 transmits the OI to the discount module 14. Following in step S34, the discount module 14 receives the OI associated with N goods. Next, in step S35, the discount module 14 accesses M2 applicable DC2 from M1 predetermined DC1 that are stored in the storing module 18, wherein M2 is a positive integer less than or equal to M1. In step S36, the discount module 14 accesses M3 applied DC3 from M2 applicable DC2 according to the OI, wherein M3 is a positive integer less than or equal to M2. In step S37, the discount 14 generates an AOD to the pricing module 16 according to the M3 applied DC3 and the OI.

Then, in step S38, the discount module 14 generates (M2-M3) notice information to the terminal module 12 according to (M2-M3) inapplicable DC4 of M2 applicable DC2. Then, in step S40, the customer decides whether to keep on purchasing goods or service according to the (M2-M3) NI produced by the terminal module 12. If the result of step S40 is no, then go to step S42. If the result of the step 40 is yes, it repeats the step S30. In other words, step S42 will be executed if the customer decides to only buy the original N goods instead of going on to purchase more goods or service after receiving the NI. In step S42, the pricing module 16 receives the OI from the terminal module 12 and accesses the amount of discount 26 from the discount module 14; then, the pricing module 16 prices N goods by subtracting the sum of N goods by the AOD 26.

If the customer purchases more than the original and supposed the number is N1 goods, the step S30 is repeated, and the OI associated with N1 goods is generated, wherein N1 and N are natural numbers, and N1 is larger than N. The N1 may include the original N goods, or part of the N goods may be added or deleted. In other words, if the customer decides to keep on purchasing more or less goods after receiving the (M2-M3) NI produced by the terminal module 12 in the step 40, the inputted order information will be amended, followed by step 30 and other procedures; then, the process proceed to price N1 goods.

One statement to make is that the data processing system and method of the present invention can be applied in dot-com companies run through the Internet or in real shops or shopping centers such as direct merchants, department stores, etc.

The following will give another example to describe in detail how the merchants provide discounts and how customers purchase goods, according to the data processing method of the present invention.

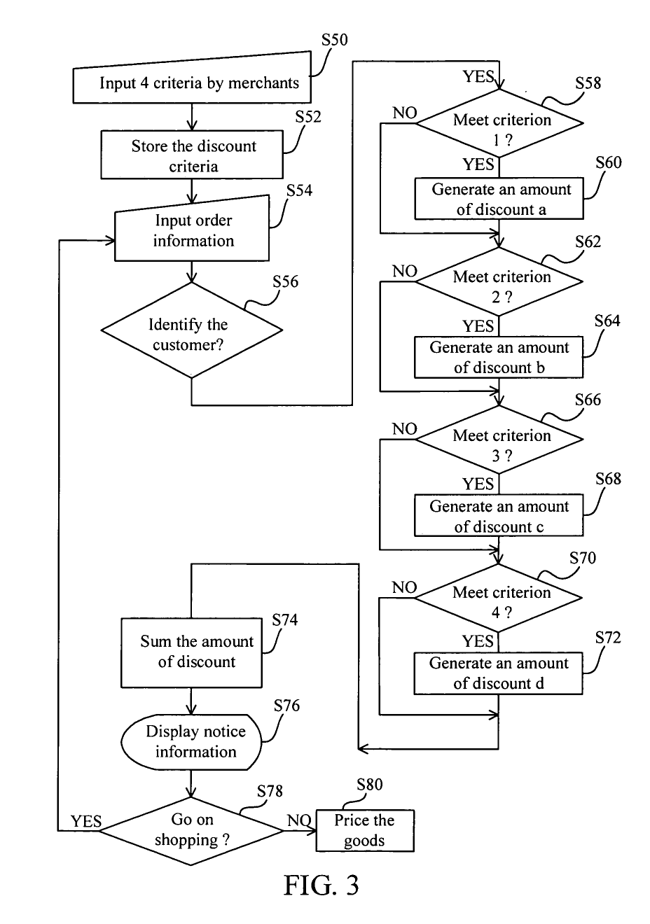

Referring to FIG. 3, FIG. 3 is a flow chart of an embodiment of the data processing procedures according to the present invention. First of all, merchants need to make discount criteria depending on real situations before customers purchase goods. Therefore, step S50 needs to be performed first. In step 50, merchants set up four discount criteria through the operational interface. These criteria comprises: criterion 1, purchasing five red pens gives $20 NT of discount; criterion 2, purchasing two or more books gives ten percent discount; criterion 3, spending up to $500 NT gives thirty percent discount, and criterion 4, delivery is free if final spending is up to $500 NT. In this embodiment, delivery charges are taken into consideration of whether to give discount or not. In practical application, delivery charges can be excluded from this kind of consideration.

Then, go to step S52; the 4 criteria set up by the merchants are stored as predetermined discount criteria.

Next, in step S54, the order information regarding the goods to be purchased by a customer is inputted into the terminal module 12. The order information includes four red pens, one book A, and two books B to be purchased by the customer. Price data about the goods are stored in advance in a database of goods. Price data about the goods previously mentioned are as follows: $20 NT per red pen, $200 NT per book A, and $150 NT per book B. As in general actual consumer behaviors, the customer will input personal information about credit cards or member cards before ordering goods. Therefore, the order information includes the data associated with the customer.

In the illustration, the four discount criteria set up by the merchants are provided for members to attract consumers to join the membership. Therefore, a customer needs to be identified first before the amount of discount is calculated. After step S54, go to step S56. In the step S56, the customer is identified by the order information. If the confirming result is yes, go to step S58.

In the step S58, the number of red pens to be purchased by the customer is compared with the first predetermined discount criteria to check whether criterion 1 is met. Because the customer only purchased four red pens, criterion one is not met; the result of step S58 is no, so step S60 is jumped over, and step S62 is performed. If the result of step S58 is yes, then step S60 follows. In step S60, the amount of discount ‘a’ will be calculated.

Next, in step S62, the number of books to be purchased by the customer is checked to see if it meets criterion 2. Because the customer purchased one book A and two books B, the criterion 2 is met; the result of step S62 is yes, and then step S64 is performed. In step S64, buying up to two books gives ten percent discount, and the amount of discount ‘b’ ($50 NT) is given.

Then, step S66 is performed, the result is checked to see if it meets criterion 3. Since the sum of the amount ($580 NT) spent subtracting the amount of discount b ($50 NT) is $530 NT, the customer spent more than $500 NT, meeting the criterion 3 to get a thirty percent discount. Therefore, the result of step S66 is yes, and then step S68 follows. In step S68, an amount of discount ‘c’ ($159 NT) is generated.

Next, in step S70, the result is checked to see if it meets criterion 4. After comparing with the three above mentioned criteria, the customer should pay $530 NT−$159 NT=$371 NT, so the final consumption amount is below $500 NT, and that does not meet the criterion 4 of spending up to $500 NT for free delivery. The result of step S70 is no, so step S70 is jumped over, and step S72 is performed. In step S72, an amount of discount ‘d’ will be calculated. Then, step S74 follows, and the total amount of discount are summed up.

In the next step S76, after comparing with the four predetermined discount criteria, the system can indicate that the customer just have to buy one more red pen to meet criterion 1, and if $129 NT more is spent, that will meet criterion 4. In the step S76, through the terminal module 12, the system will notify the customer that buying one more red pen will meet criterion, and consuming $129 NT more will earn free delivery, so as to attract the customer to keep on purchasing.

In step S78, the customer may decide whether to keep on purchasing after receiving the notice. If the result of the step S78 is no, step S80 follows. Pricing will be done through the sum of the prices of goods purchased by the customer subtracting the amount of discount, so that the customer should pay a sum of $396 NT, including delivery charges. If the result of step S78 is yes, go back to step S54 to receive the order information of whether the customer wants to add or delete items of purchase.

The summed up features and advantages of the invention is as follows: Pricing according to the pricing system and method of the present invention for multiple discounts well meet the promotional behavior in realistic commercial activities; and Not only providing the customer available data of discount, but notifying immediately the related information associated with inapplicable discount in order to stimulate the customer to go on purchasing more.

In practical application, the customer can input the above-mentioned order information over the Internet, if he/she would purchase the goods through online purchasing. If the customer would purchase the goods in a supermarket, the inputting of the above-mentioned order information can be achieved by a conventional cash register or a novel technique—Radio Frequency Identification (RFID) technique. The multiple discount system according to the invention may combine with the RFID technique to provide customers with a more comfortable and convenient shopping environment.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A data processing system for pricing N goods to be purchased by a customer, based on M1 predetermined discount criteria, wherein M1 and N are natural numbers, said system comprising:
a storing module for storing M1 predetermined discount criteria;
a terminal module for inputting an order information comprising data associated with N goods;
a discounting module for receiving the order information from the terminal module, accessing M2 applicable discount criteria from the storing module based on the order information, selecting M3 applied discount criteria from M2 applicable discount criteria according to the order information, and generating an amount of discount relative to N goods according to the M3 applied discount criteria and the order information, wherein M2 is a positive integer less than or equal to M1, and M3 is a positive integer less than or equal to M2; and
a pricing module for receiving the order information from the terminal module and the amount of discount from the discounting module, and pricing N goods by subtracting the sum of all prices of N goods by the total amount of discount.

2. The data processing system of claim 1, wherein the discounting module also generates (M2-M3) notice information according to (M2-M3) inapplicable discount criteria in the M2 applicable discount criteria and the order information; each notice information corresponds to one of the (M2-M3) inapplicable discount criteria, and the discounting module then outputs the (M2-M3) notice information to the terminal module.

3. The data processing system of claim 1, further comprising:
an editing module for selectively adding, deleting, or amending the discount criteria stored in the storing module.

4. The data processing system of claim 1, wherein the order information also comprises identification data associated with the customer.

5. The data processing system of claim 1, wherein the order information also comprises the shopping site data associated with the customer.

6. A data processing method for pricing N goods being purchased by a customer, based on M1 predetermined discount criteria, wherein M1 and N are natural numbers respectively, said method comprising the steps of:
receiving order information comprising data associated with N goods;
accessing M2 applicable discount criteria from M1 predetermined discount criteria, wherein M2 is a positive integer less than or equal to M1;
according to the order information, selecting M3 applied discount criteria from M2 applicable discount criteria, wherein M3 is a positive integer less than or equal to M2;
according to M3 applied discount criteria and the order information, generating an amount of discount a; and
pricing N goods by subtracting a sum of all prices of N goods by the total amount of discount.

7. The data processing method of claim 6, further comprising the steps of:
according to (M2-M3) inapplicable discount criteria in the M2 applicable discount criteria and the order information, generating (M2-M3) notice information which each notice information corresponds to one of the (M2-M3) inapplicable discount criteria; and
outputting the (M2-M3) notice information to the terminal module.

8. The data processing method of claim 6, further comprising the steps of:
selectively adding, deleting, or amending the M1 predetermined discount criteria.

9. The data processing method of claim 6, wherein the order information also comprises identification data of the customer.

10. The data processing method of claim 6, wherein the order information also comprises the shopping site data of the customer.

11. A computer program product comprising a storage having a computer program, embedded in storage medium, for pricing N goods being purchased by a customer, based on the M1 predetermined discount criteria, wherein M1 and N are natural numbers respectively, said program performing the steps of:
receiving the order information comprising data associated with N goods;
according to the order information, accessing M2 applicable discount criteria from M1 predetermined ones, wherein M2 is a positive integer less than or equal to M1;
according to the order information, selecting M3 applied discount criteria from M2 applicable ones, wherein M3 is a positive integer less than or equal to M2;
according to M3 applied discount criteria and the order information, generating an amount of discount; and
pricing N goods by subtracting a sum of all prices of N goods by the amount of discount.

12. The computer program product of claim 11, further performing the steps of:
according to the (M2-M3) inapplicable discount criteria of M2 applicable discount criteria and the order information, generating (M2-M3) notice information which each notice corresponds to one of (M2-M3) inapplicable discount criteria; and
outputting the (M2-M3) notice information to the terminal module.

13. The computer program product of claim 11, further performing the steps of:
selectively adding, deleting, or amending the M1 predetermined discount criteria.

14. The computer program product of claim 11, wherein the order information also comprises identification data of the customer.

15. The computer program product of claim 11, wherein the order information also comprises the shopping site data of the customer.
